(19) United States
(12) Patent Application Publication
(10) Pub. No.: US 2021/0364660 A1
(43) Pub. Date: Nov. 25, 2021

(54) MULTILAYER SCINTILLATOR DETECTOR AND METHOD FOR RECONSTRUCTING A SPATIAL DISTRIBUTION OF A BEAM OF IRRADIATION

(71) Applicants: UNIVERSITE CLAUDE BERNARD LYON 1, Villeurbanne (FR); INSTITUT NATIONAL DES SCIENCES APPLIQUEES DE LYON, Villeurbanne (FR); CENTRE NATIONAL DE LA RECHERCHE SCIENTIFIQUE, Paris (FR); HOSPICES CIVILS DE LYON, Lyon (FR); CPE LYON FORMATION CONTINUE ET RECHERCHE, Villeurbanne (FR); ECOLE CENTRALE DE LYON, Ecully (FR)

(72) Inventors: Patrick PITTET, Fontaines Saint Martin (FR); Guo-Neng LU, Saint-Fons (FR); Patrice JALADE, Brindas (FR); Jean-Marc GALVAN, Villeurbanne (FR)

(73) Assignees: UNIVERSITE CLAUDE BERNARD LYON 1, Villeurbanne (FR); INSTITUT NATIONAL DES SCIENCES APPLIQUEES DE LYON, Villeurbanne (FR); CENTRE NATIONAL DE LA RECHERCHE SCIENTIFIQUE, Paris (FR); HOSPICES CIVILS DE LYON, Lyon (FR); CPE LYON FORMATION CONTINUE ET RECHERCHE, Villeurbanne (FR); ECOLE CENTRALE DE LYON, Ecully (FR)

(21) Appl. No.: 16/982,429

(22) PCT Filed: Mar. 20, 2019
(86) PCT No.: PCT/FR2019/050637

§ 371 Date: Sep. 18, 2020

(30) Foreign Application Priority Data
Mar. 22, 2018 (FR) 18 52480

(51) Int. Cl. G01T 1/20

(52) U.S. Cl. CPC G01T 1/2008; G01T 1/2018

(57) ABSTRACT

A multilayer scintillation detector, includes at least three layers superposed on one another, and each extending parallel to a plane, called the detection plane, wherein each layer is formed by a first material, called a scintillation material, capable of interacting with an ionizing radiation and of forming, following the interaction, a scintillation light in a scintillation spectral band; each layer has a plurality of light guides, respectively extending parallel to the detection plane, according to a length, the light guides being disposed, over all or part of their length, parallel to an axis of orientation; the axis of orientation of the light guides of each layer is oriented, in the detection plane, according to an orientation, the orientations of the respective axes of orientation of at least three layers being different from one another, such that each layer has an associated orientation; and the scintillation material has a first refractive index.

### TECHNICAL FIELD

The technical field of the invention is the dosimetry linked to measurements and checks on beams generated by medical linear accelerators used in radiotherapy and notably the beams in stereotactic radiotherapy.

### PRIOR ART

A certain number of excessive irradiations of patients have occurred, caused by an overexposure to ionizing radiations in radiotherapy treatments. These irradiations have led to serious sequelae, even deaths. The result thereof is a need to have a better quality in the predicting of the doses administered to the patients.

Currently, the dose delivered to the patient is estimated using computation code modellings, in order to best estimate the dosimetry at the level of the tumors or of the organs that are most sensitive, the measured data, on which the computation codes are based, have to be better controlled, notably for the small beams. The control of the dose delivered involves comparisons between doses that are modelled and doses that are measured in real time, on a patient, or even between doses that modelled and doses that are measured experimentally, on phantoms representative of the body of a patient.

The problem arises notably in the field of stereotactic radiotherapy, this modality successively implementing convergent irradiating beams of small size, so as to selectively irradiate a target of small volume, typically of the order of a cm³. Generally, the irradiating beam has a diameter or a greater diagonal of less than a few cm, for example 3 cm. The irradiation source can be a radio-isotope, for example ⁶⁰Co, or a particle accelerator, for example a linear accelerator (LINAC), that makes it possible to obtain an X-ray or high-energy electron beam, that can potentially reach a few tens of MeV, The irradiating beams converge toward the target to be treated either by rotation, or by the geometry and the positioning of multiple sources of ⁶⁰Co.

The beam emitted by the irradiation source passes generally through a collimator, notably a multi-plate collimator, composed of a plurality of dense plates whose arrangement makes it possible to obtain a spatial distribution of the dose corresponding to the geometry of the target to be treated. Each plate of the collimator can be disposed in such a way that the set of plates delimits an aperture matched to the target. In some cases, these plates are displaced during the delivery of the dose, making it possible to adapt the fluence of the photons at the target level in order to match the dose distribution as closely as possible to the lesion to be treated. This technique, called intensity-modulated conformal radiotherapy (referred to by the acronym IMCR), makes it possible to protect the healthy tissues adjacent to the target, while concentrating the dose on the target. During a rotation about the target, the configuration of the collimator can also change, so that the projection of the aperture onto the target encompasses the latter throughout the rotation.

The small stereotactic irradiation fields can also be obtained with other types of collimators, for example collimators formed with circular cones.

The irradiation beams implemented in stereotactic radiotherapy are characterized by a small size and a strong dose gradient, in particular at the periphery of the beam. Moreover, because of the small size of the irradiated zone, the condition of electronic equilibrium, in the irradiated target, may not be observed. These particular features lead to an uncertainty in the modelling of the dose integrated during an irradiation.

In order to check the dose actually delivered, experimental measurements are frequently implemented, for quality assurance purposes. Currently, the use of passive dosimeters, of radiochromic film or thermoluminescence cube type, is considered a benchmark method. These dosimeters make it possible to obtain a quantitative two-dimensional distribution of the dosimetry, complemented by punctual information when thermoluminescent cubes are used. However, implementing them is complex, takes a long time and is relatively costly, which is difficult to square with daily use. Furthermore, these dosimeters do not deliver information in real time. In addition, they are not suited to stereotactic radiotherapy guided by MRI (magnetic resonance imaging). Indeed, it has been shown that the performance of these dosimeters can be degraded by the intense magnetic fields generated by MRI.

Various alternatives to the passive dosimeters have been studied. For example, the document US2012/0292517 describes a scintillation detector, comprising scintillating optical fibers arranged parallel to one another. This detector is intended to be used for the quality control associated with radiotherapy. It can notably comprise different layers, extending parallel to one another, the fibers of one and the same layer being oriented parallel to one another, according to an orientation. However, the use of a fiber detector presents a number of drawbacks. A first limitation is linked to the size of the fibers, whose diameter is 0.5 mm, which does not make it possible to obtain an adequate spatial resolution. Furthermore, it is tedious to arrange several tens, even hundreds, of fibers alongside one another, such that the fibers are parallel to one another. Another limitation is linked to the coupling of the fibers with a photodetector, the fibers being in direct contact with the photodetector. The result thereof is a complex design, and a device that is relatively bulky and probably costly.

The publication, by Goulet M. entitled “High resolution 2D device based on a few long scintillating fibers and tomographic reconstruction”, Med. Phys., 39 (8) August 2012, describes the use of a detector comprising optical fibers, of 1 mm diameter, extending parallel to one another, on a plane. The detector is rotationally movable. Upon an exposure of the detector to an irradiation beam the detector is successively turned according to different orientations. The measurements performed on each orientation are used in a tomography algorithm to obtain a spatial distribution of the irradiation beam. Such a method presents limitations linked to the use of the optical fibers. Furthermore, it requires a sequential rotation of the detector, the latter having to be accurate if the aim is to obtain a good quality tomographic reconstruction. The sequential acquisition, according to different orientations, is affected by possible temporal variations of the irradiation beam. The method is therefore relatively complex to implement, because of the presence of a means for rotating the detector. A method based on the use of optical fibers is also described in US20140217295.

Another detector, targeting the same type of application, is described in US2009/0236510. The device comprises fibers of which one spot end is scintillating, to generate a light signal representative of a dose. The scintillating end is linked to a non-scintillating fiber whose function is to guide the light signal to an image sensor, of CCD or CMOS type. Such a detector presents the same drawbacks as those cited concerning US2012/0292517, namely a complex setup, reflected by a high cost, and a certain bulk, because of the presence of fibers extending to the detector. Moreover, only the end of the fibers is scintillating, the scintillating volume being less than 2 mm³. Such a detector is suitable in the case of spot measurements, but is not suited to the performance of a measurement of the spatial distribution of the dose in an irradiation beam whose diagonal is of the order of 2 or 3 cm.

The inventors have developed a detector that is simple, inexpensive and easy to implement for experimentally measuring a dose delivered by an ionizing radiation beam extending along a diagonal of a few centimeters. The detector makes it possible to simply evaluate a two-dimensional spatial distribution of the irradiation beam.

### SUMMARY OF THE INVENTION

A first subject of the invention is a multilayer scintillation detector, comprising at least three layers superposed on top of one another, and each extending parallel to a plane, called detection plane, the detector being such that:

each layer comprises a first material, called scintillation material, that can interact with an ionizing radiation and form, following the interaction, a scintillation, light in a scintillation spectral band;
each layer comprises a first material, called scintillation material, that can interact with an ionizing radiation and form, following the interaction, a scintillation light in a scintillation spectral band;
each layer comprises a plurality of light guides extending respectively parallel to the detection plane, according to a length, and being disposed, over all or part of their length, parallel to an axis of orientation;
the axis of orientation of the light guides of one and the same layer is oriented, in the detection plane, according to an orientation, the orientations of the respective axes of orientation of at least three layers being different from one another, such that each layer has an associated orientation;
the scintillation material has a first refractive index;
   the detector being characterized in that each layer is formed by a plate, comprising the scintillation material, extending parallel to the detection plane, and such that;
the plate comprises channels, formed in the plate, and extending parallel to the detection plane, according to the orientation associated with the layer;
each channel is filled by a second material, of a second refractive index, strictly lower than the first refractive index;
such that, between two adjacent channels, there extends a light guide, formed by the scintillation material, and capable of generating a scintillation light under the effect of an irradiation by the ionizing radiation, and of propagating the scintillation light according to the axis of orientation of the layer.

The scintillation spectral band can be situated in the visible or in the near ultraviolet. It generally lies within the 200 nm-800 nm spectral range.

The number of layers is preferably between 3 and 20.

The plate, in which the channels are formed, can comprise a non-scintillating bottom part, such that, after the formation of the channels, the light guides rest on the bottom part. The latter keeps the light guides parallel to one another.

The channels can extend to all or part of a thickness of the plate, and preferably to 90% of the thickness of the plate, the thickness being defined at right angles to the detection plane.

The light guides of each layer are kept, by the plate, secured to one another,

According to one embodiment, each light guide of one and the same layer extends, according to the detection plane, to a face of the detector, called detection face, the detection face being disposed transversely to the detection plane, and preferably at right angles thereto, such that the scintillation light generated in the light guide is propagated to the detection face. The device can comprise several detection faces that are different from one another, each detection face comprising ends of light guides formed in one and the same layer. A detection face can comprise ends of light guides formed in different layers.

The detector can have, in the detection plane, a polygonal section.

The height of at least one light guide, at right angles to the detection plane, preferably lies between 100 μm and 1 mm. The width of a light guide, in the detection plane, at right angles to the axis of orientation according to which the light guide extends, preferably lies between 100 μm and 500 μm.

The second material can be air. The first material can be an organic scintillator.

At least one layer can be separated from another layer which is superposed on it by a thickness of a third material, of a third optical index, lower than the first optical index and/or opaque and/or reflecting.

According to one embodiment, at least one layer comprises a so-called auxiliary detector, disposed in a channel, called measurement channel, the auxiliary detector being able to induce an optical or electronic signal when it is exposed to the ionizing radiation. The auxiliary detector can be formed by a solid material, linked to an optical or electrical connection, the connection extending in the measurement channel. The auxiliary detector is preferably a point detector, the auxiliary detector having a detection volume less than 1 mm³, and preferably less than or equal to 0.5 mm³. It can be a scintillation detector, notably of gallium nitride (GaN), linked to an optical fiber, the latter forming the optical connection.

According to one embodiment, the detector comprises marks, formed on at least one layer, using a material forming a contrast agent in an examination by magnetic resonance imaging, such that the marks form reference points that are visible when the detector is examined by magnetic resonance imaging.

A second subject of the invention is a device for detecting an ionizing radiation, comprising:
a multilayer detector according to the first subject of the invention, the multilayer detector being formed in a scintillation material capable of generating a scintillation light when it is exposed to the ionizing radiation;
at least one pixelated photodetector, comprising several pixels;
such that each pixel is configured to be optically coupled to a light guide formed in a layer of the multilayer detector, so as to collect the scintillation light emanating from the light guide to which it is coupled.

The device can comprise at least one optical coupling system, such that each pixel is optically coupled to a light guide by the optical coupling system. The optical coupling system can comprise optical fibers or one or more lenses.

According to one embodiment, at least one layer of the multilayer scintillation detector comprises an auxiliary detector, disposed in a channel, called measurement channel, the auxiliary detector being able to induce an optical or electronic signal when it is exposed to the ionizing radiation, the detection device comprising a measurement unit, linked to the auxiliary detector, and configured to measure a level of irradiation detected by the auxiliary detector. The auxiliary detector can be a scintillator of GaN type, linked to an optical fiber, the optical fiber extending in the measurement channel.

A third subject of the invention is a method for reconstructing a two-dimensional spatial distribution of an irradiation beam emitted by an irradiation source, using the detection device according to the second subject of the invention, the method comprising the following steps:
a) irradiation of the multilayer scintillation detector of the detection device by an irradiation source, the multilayer scintillator extending according to a detection plane, the irradiation source forming an irradiation beam that is propagated through the detection plane;
b) detection, by pixels of the detection device, of a quantity of scintillation light emanating from each layer of the multilayer scintillator, so as to obtain, for each layer of the scintillator, a projection of the irradiation beam, in the detection plane, according to the orientation of the light guides of each layer;
c) from each projection obtained according to the step b) estimation, of a two-dimensional spatial distribution of the irradiation beam in the detection plane.

According to one embodiment,
the multilayer scintillation detector comprises an auxiliary detector, disposed in a channel, called measurement channel, the auxiliary detector being able to induce an optical or electronic signal when it is exposed to the ionizing radiation;
the detection device comprises a measurement unit, linked to the auxiliary detector, and configured to measure a level of irradiation detected by the auxiliary detector;
the method can then comprise a step d) of realignment of the two-dimensional spatial distribution estimated in the step c) from the level of irradiation detected by the auxiliary detector.

The steps a) to c) can be performed by arranging a multilayer scintillation detector at different distances from the irradiation source, so as to obtain, for each distance, a two-dimensional spatial distribution of the irradiation.

Other advantages and features will emerge more clearly from the following description of particular embodiments of the invention, given as nonlimiting examples, and represented in the figures listed below.

### FIGURES

FIGS. 1A, 1B and 1C show the main components of a stereotactic radiotherapy station.

FIG. 2A schematically represents an example of a multilayer scintillator according to the invention. FIG. 2B is a detail of FIG. 2A.

FIGS. 3A, 3B and 3C are plan views of the layers of the multilayer scintillator represented in FIG. 2A.

FIG. 4A is a diagram of a detection device implementing the multilayer scintillator described in relation to FIGS. 2A to 3C. FIG. 4B illustrates a variant of the detection device.

FIG. 5A represents another example of a multilayer scintillator, of trapezoidal section.

FIG. 5B is another example of a multilayer scintillator, of pentagonal section.

FIGS. 6A, 6B and 6C schematically represent another example of a multilayer scintillator, arranged so as to have only a single detection face.

FIG. 7 illustrate a layer of a multilayer scintillator according to an embodiment implementing an auxiliary detector.

FIGS. 8A and 8B show experimental results obtained by implementing a multilayer scintillator. The same applies for FIGS. 9A to 9E.

FIGS. 10A, 10B, 10C, 10D, 10E and 10F schematically represent different orientations respectively associated with the layers of a multilayer scintillator.

FIGS. 11A to 11C concern a reconstruction of a two-dimensional spatial distribution of an irradiation beam emitted by an irradiation source. FIG. 11A describes the main steps of the reconstruction method. FIG. 11B shows an image of a multi-plate collimator implemented. FIG. 11C shows an estimation of a two-dimensional spatial distribution obtained using the method illustrated in association with FIG. 1A.

FIGS. 12A and 12B each illustrate a phantom comprising several multilayer scintillators.

### DESCRIPTION OF PARTICULAR EMBODIMENTS

Unless explicitly stated otherwise, the term “a” should be interpreted to mean “at least one”. Moreover, the arrangement is in an orthogonal reference frame defined by the axes X, Y and Z, the Z axis corresponding to the vertical axis.

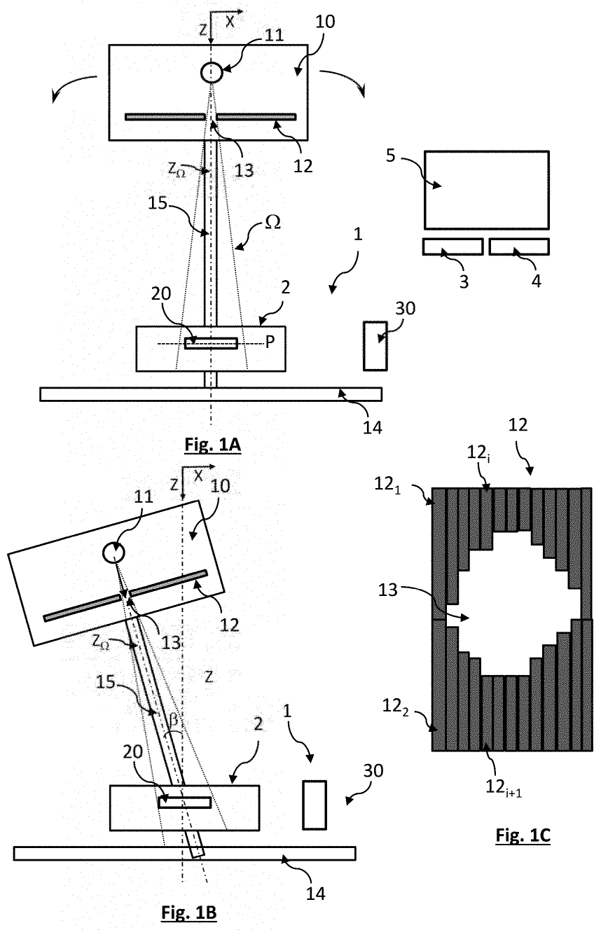

FIG. 1A schematically represents the main components of a stereotactic radiotherapy installation. The installation comprises a head 10, held by an arm 15, and comprising an irradiation source 11 disposed facing a multi-plate collimator 12, the latter defining an aperture 13. The multi-plate collimator defines a parameterizable aperture 13, allowing the passage of an ionizing radiation beam Ω emitted by the irradiation source 11, to define a spatial extent of the irradiation beam. Ionizing radiation is understood to be a beam of ionizing photons, for example of γ photons or X photons, or a charged particle beam, for example of protons or electrons. The irradiation source 11 can be a radio-isotope, and comprise, for example, one or more sources of ⁶⁰Co. Alternatively, can comprise a particle accelerator, configured to it an X-ray beam whose energy is distributed according to an energy spectrum. Generally, the irradiation source produces an intense irradiation beam Ω, according to an irradiation axis Z_{Ω}, so as to expose a target tissue, for example a cancerous tumor, to a previously defined exposure. The exposure, or dose, corresponds to a quantity of energy absorbed by the irradiated tissue, generally expressed per unit of weight. When this exposure is also expressed per time unit, the exposure is expressed in terms of dose rate, or instantaneous dose. The exposure depends on the spatial distribution of the dose rate.

The energy of the ionizing radiation can be between 500 keV and 22 MeV when the irradiation source comprises a particle accelerator. When it is an isotopic source, the energy of the radiation corresponds primarily to the emission lines of the source. In the case of ⁶⁰Co, the energies of emission of these lines are equal to 1173 keV and 1332 keV.

The patient undergoing the radiotherapy treatment is generally positioned on a table 14. In this example, a phantom 2 is represented, simulating the body of a patient. The phantom can be produced according to different materials exhibiting an attenuation comparable to the body of a patient (atomic number and density both very close to those of tissues), for example an organic material of PMMA (polymethylmethacrylate) type. Such a phantom is called “tissue equivalent”.

A detection device 1 is represented that makes it possible to estimate the dose generated by the irradiation beam Ω, and to estimate a two-dimensional spatial distribution thereof according to a plane. The detection device 1 comprises a multilayer scintillator 20 and at least one pixelated photodetector 30. The multilayer scintillator 20 extends essentially according to a plane, called detection plane P. Under the effect of the irradiation beam, the multilayer scintillator generates a scintillation light, the latter being guided to the photodetector 30. The scintillation light is generated in a scintillation spectral band, the latter depending on the scintillation material used. The scintillation spectral band is generally the visible or near ultraviolet range, therefore lying between 100 nm and 800 nm.

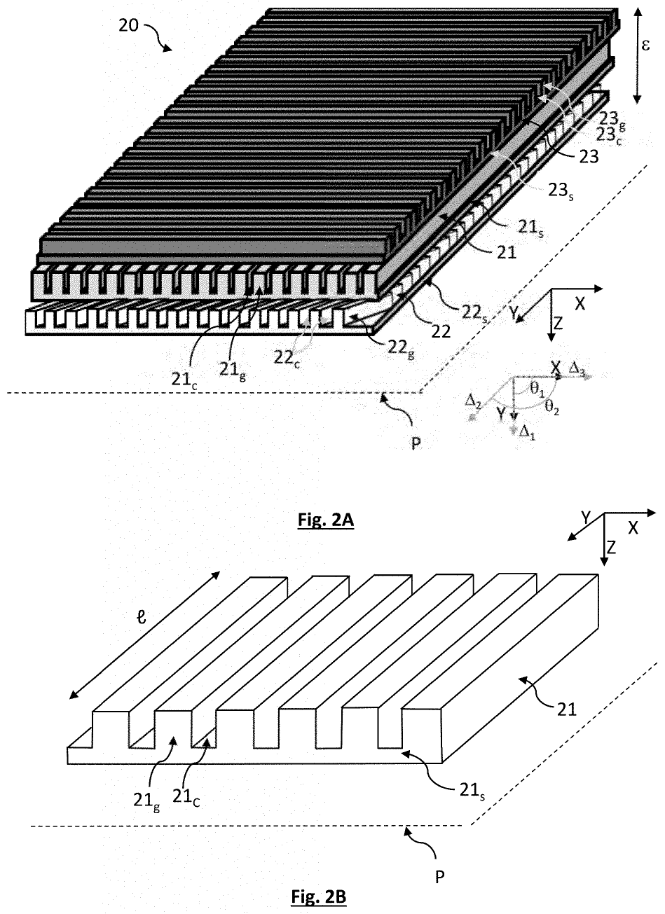

The photodetector 30 is situated at a distance from the multilayer scintillator 20. The detection device 1 also comprises a processor 3, for example a microprocessor, linked to a memory 4, comprising instructions for implementing the detection and reconstruction methods described hereinbelow. The processor 3 can be linked to a screen 5. The detection device 1, and more particularly the multilayer scintillator 20, form an important aspect of the invention, described more broadly in FIG. 2A and subsequent figures.

In the example of FIG. 1A, the irradiation beam emitted by the source 11 extends according to an axis Z_{Ω}, coinciding with the vertical axis Z. The irradiation head 10 is rotationally movable around the table 14. FIG. 1B represents the installation described in association with FIG. 1A, in which the arm 15 has undergone a rotation by an angle β in a vertical plane XZ. The irradiation beam Ω is still directed toward the phantom 2. The intersection of the irradiation axes Z_{Ω} during the different rotations of the irradiation head corresponds to the center of the target tissue to be treated, also referred to as “isocenter”.

The spatial extent of the irradiation beam Ω, at right angles to the irradiation axis Z_{Ω}, is determined by the multi-plate collimator 12. Such a collimator is represented in FIG. 1. It comprises a plurality of dense plates 12₁, 12₂, 12ᵢ, 12ᵢ₊₁ . . . produced in a material whose atomic number is high, so as to attenuate the ionizing radiation emitted by the source. It can in particular be an alloy of tungsten. Each plate is translationally movable, in a plane at right angles to the irradiation axis Z_{Ω}, so as to delimit the spatial extent of the irradiation beam Ω. The latter is defined by the aperture 13 extending between the plates of the collimator 12. In the example represented, a plate 12ᵢ is situated facing an opposite plate 12ᵢ₊₁. The aperture 13 of the collimator 12 is parameterized by moving each plate 12ᵢ closer to or away from the plate 12ᵢ₊₁ which is opposite it. Thus, the aperture 13 can easily be modulated, and can be modified continuously and/or on each rotation of the irradiation head 10, between two successive irradiations. The modulation of the aperture 13 is performed, according to a treatment protocol, by taking account of the volume of the target tissue and the presence of healthy tissues adjacent to the target tissue, or extending into the irradiation beam Ω upstream or downstream of the target tissue.

As indicated in the prior art, the diameter or the greater diagonal of a section of the irradiation beam Ω, at right angles to the axis of propagation Z_{Ω}, can be less than 5 cm, even than 3 cm. Generally, at the target tissue, the surface of the irradiation beam Ω, at right angles to the irradiation axis Z_{Ω}, is less than 50 mm².

FIG. 2A represents an example of a multilayer scintillator 20 forming an object of the invention. The multilayer scintillator comprises three distinct layers 21, 22 and 23. The three layers extend parallel to a detection plane P, corresponding in this example to the plane XY. The first layer 21 will be described, bearing in mind that its structure is similar to that of the second layer 22 and of the third layer 23.

The first layer 21 is formed by a support plate 21ₛ, also referred to by the term “scintillating sheet”, produced according to a first material, called scintillation material. The support plate 21ₛ extends according to the detection plane P. As previously described, the first material is a scintillation material, capable of generating a scintillation light when it is exposed to an irradiation. The scintillation material is for example an organic scintillator. Indeed, such a scintillator is called “tissue equivalent”; when it is exposed to an irradiation beam, it generates a scintillation light whose intensity is proportional to an instantaneous dose which would be delivered to a biological tissue. The organic scintillators are materials commonly used in the field of nuclear measurement. They can be available in different sizes, at a reasonable cost. Their response time is rapid and they exhibit a generally low remanence, making them particularly appropriate to repeated exposures to intense irradiation beams. Furthermore, they can easily be structured by simple microstructuring methods. In the present case, the material used is the reference BC408 from the manufacturer Saint Gobain Crystals. It can emit a scintillation light according to a scintillation spectral band centered on the 425 nm wavelength. Other organic scintillation materials known to a person skilled in the art can be used, and for example the reference BC412 (Saint Gobain Crystals), or even the references SCSF-78, SCSF-81, SCSF-3HF (Kuraray), or the reference EJ200 (Eljen Technologies). It is also possible to use a scintillating resin, for example the reference BC490 (Saint Gobain Crystals).

The scintillation material has a first optical refractive index n₁. Generally, the first refractive index is, at a wavelength of 450 nm, greater than, or equal to 1.3, even 1.5. In the case of BC408, the refractive index is equal to 1.58 at this wavelength.

The support plate 21_{c} has been structured, so as to form hollow channels 21_{c} extending along the plate, according to a length l. Over all or part of the length l, the hollow channels 21, extend parallel to one another, being oriented according to a first axis of orientation Δ₁. The first axis of orientation Δ₁ is coplanar to the detection plane P according to which the first support plate 21 extends. The thickness of the support plate 21ₛ, before the formation of the channels 21_{c}, can lie between 100 μm and 5 mm. It is preferably less than 2 mm, and more preferably less than 1 mm. The channels are formed to all or part of a thickness of the support plate 21ₛ, the thickness of the plate extending at right angles to the detection plane.

The structuring of the channels 21_{c} makes it possible to delimit light guides 21_{g}, each light guide extending between two adjacent channels, parallel thereto. It is important for the light guides to extent parallel to one another, according to the first axis of orientation Δ₁, in at least a central part of the layer 21ₛ, intended to be exposed to the irradiation beam Ω. In the example represented, the channels 21_{c} and the light guides 21_{g} extend parallel to one another, according to the first axis of orientation Δ₁, over all their length.

FIG. 2B shows a detail of the first layer 21. After the formation of the, channels 21_{c}, there may remain, at the latter, a thinner part of the support plate 21ₛ, the latter having a residual thickness of between 10 μm and 100 μm. After the structuring, the support plate bears the light guides and ensures the holding thereof. Each channel 21_{c} extends:
at right angles to the first axis of orientation Δ₁ (oriented according to the axis Y), according to a width preferably lying between 10 μm and 100 μm, and preferably between 40 μm and 80 μm, for example 60 μm;
at right angles to the detection plane P, according to a depth preferably lying between 50% and 90% of the initial thickness of the support plate 21ₛ. It preferably lies between 100 μm and 1 mm. In this example, the depth of each channel 21_{c} is 500 μm. The depth conditions the detection sensitivity.

After the structuring of the support plate 21ₛ, each channel 21_{c} is filled with a second material, different from the first material forming the support plate 21ₛ. The second material has a refractive index n₂ lower than that of the first material. In the examples described, the second material is air. The second material is, preferably, non-scintillating.

According to one embodiment, the support plate comprises a bottom part, corresponding to the thinner part, formed by a support material different from the scintillation material. The support material is preferably non-scintillating, and its refractive index is advantageously lower than the refractive index of the scintillation material. The support material is for example a plastic material. After the formation of the channels, the light guides 21_{g} are held by the bottom part of the support plate 21ₛ, the latter serving as non-scintillating support. The support material can, preferably, have a refractive index lower than the refractive index of the scintillation material.

Between two adjacent channels 21_{c} there extends a light guide 21_{g}. The height of the light guide, at right angles to the detection plane P, corresponds to the depth of the adjacent channels. The higher it is, the greater the detection sensitivity. Like the channels 12_{c}, each light guide 21_{g} extends according to the axis of orientation Δ₁ of the first layer 21. The width of a light guide, at right angles to the axis of orientation Δ₁, preferably lies between 100 μm and 500 μm, for example between 200 μm and 300 μm. This width conditions the spatial resolution of the detection, as is understood from the experimental tests described hereinbelow.

The first plate 21ₛ, structured thus, forms a first layer 21 of the multilayer scintillator 20. Under the effect of an exposure to an irradiation beam Ω, a scintillation light is generated by the first layer 21, in particular within each light guide (or waveguide) 21_{g}, the volume of the first layer 21 being essentially composed of the light guides 21_{g}. Because of the difference in refractive index between each light guide 21_{g} and the channels 21_{c} that are adjacent to it, the scintillation light generated within each light guide 21_{g} is propagated therein, according to the axis of orientation Δ₁.

The structuring of the first layer can be performed by a method combining an etching method and lithography, for example photolithography, or by thermoforming of “hot embossing” type, or by molding or even by micro-machining. It makes it possible to simultaneously obtain a large number of waveguides, of small width, within one and the same layer, this number exceeding 100, even 1000. That makes it possible to perform measurements by benefiting from a high spatial resolution. When photolithography is implemented, it can be UV photolithography, for example at 375 nm, through a chrome on glass mask. A structured scintillator is thus obtained.

The structuring of the support plate makes it possible to simultaneously obtain waveguides of small width, separated from one another by a few tens of microns, and secured to one another. The waveguides are fixed to one another, being held by the thinner part of the support plate. A layer produced in this way is easily manipulable.

The second layer 22 and the third layer 23 have a structure similar to the first layer 21. They extend according to the same detection plane P. Thus, the second layer comprises light guides 22_{g}, delimited by channels 22_{c}, and extending, over at a least a part of their length, parallel to a second axis of orientation Δ₂. The second axis of orientation is parallel to the detection plane P, but not parallel to the first axis of orientation Δ₁. Thus, when the second, layer is exposed to an irradiation beam, a scintillation light is generated in each light guide 22_{g}, and is propagated in each of them, according to the second axis of orientation Δ₂.

Similarly, the third layer comprises light guides 23_{g}, delimited by channels 23_{c}, and extending, over at least a part of their length, parallel to a third axis of orientation Δ₃. The third axis of orientation is parallel to the detection plane P, but not parallel to the first axis of orientation Δ₁, or to the second axis of orientation Δ₂.

FIG. 2A shows the axes of orientation Δ₁, Δ₂ and Δ₃ relative to the reference frame XY of the detection plane P. The angle of orientation denotes the angle between the vector X of the reference frame XY and the axis of orientation of the layer. Each layer has an associated orientation, defined by the angle of orientation, Thus:
The first layer 21 has an associated first orientation θ₁, according to which the scintillation light generated in said layer is propagated. In this example, θ₁≈90°.
The second layer 22 has an associated second orientation θ₂, according to which the scintillation light generated in said layer is propagated. In this example, θ₂=135°.
The third layer 23 has an associated third orientation θ₃, according to which the scintillation light generated in said layer, is propagated. In this example, θ₃=0°. The angle θ₃ is not represented in FIG. 2A.

Two layers can be directly superposed on one another. Alternatively, a third material, of a third refractive index n₃, can extend between two adjacent layers. The third material can be identical to the second material, for example air. In this case, spacers are used to space apart two superposed layers. When the two adjacent layers are not in contact with one another, the distance separating them is preferably as small as possible, for example between 10 μm and 100 μm. The third refractive index n₃ is preferably lower than the first refractive index n₁, in the scintillation spectral band, notably when the third material is transparent in the scintillation spectral band. That allows for a better containment of the light in the light guides. Alternatively, the third material can be an opaque material, so as to optically isolate the two superposed layers that it separates. The third material can also be reflecting. When the support plate comprises a bottom part formed by a non-scintillation material, as previously described, the non-scintillation material can be the third material.

The thickness ε of the structured multilayer scintillator 20, at right angles to the detection plane P, is as small as possible, such that the layers can be considered to be exposed to one and the same irradiation beam, according to one and the same plane. The thickness ε of the multilayer scintillator must however allow each layer to have a sufficient thickness for the detection sensitivity to be acceptable. The thickness ε of the multilayer scintillator varies according to the number of layers, but it is preferable for it to be less than 2 cm or 1 cm.

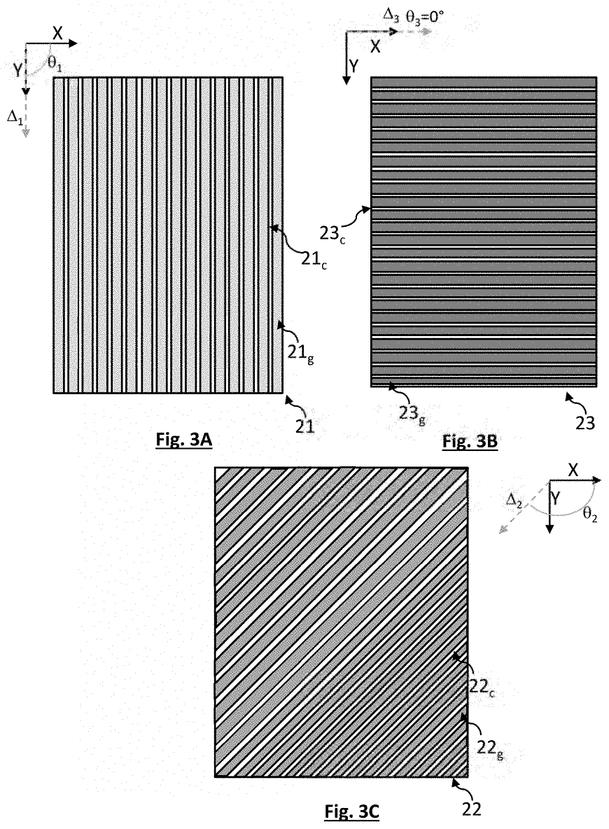

FIGS. 3A, 3B and 3C represent respective plan views of the first layer 21, of the third layer 23 and of the second layer 22. These views make it possible to appreciate the orientation angles θ₁, θ₃ and θ₂ respectively associated with each layer, each orientation angle being different from one another.

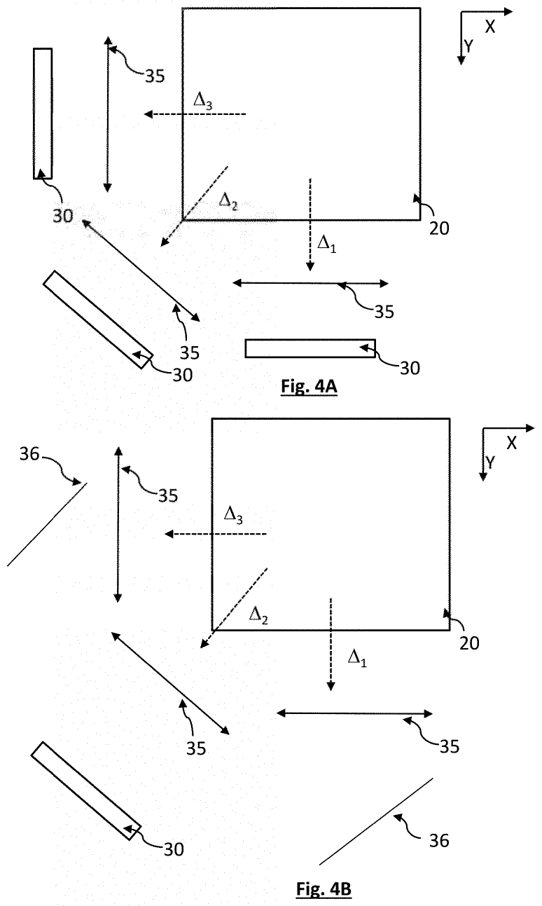

FIG. 4A represents the detection device 1, comprising the multilayer scintillator 20 described in association with FIGS. 2A to 3C. The device comprises three pixelated photodetectors 30. Each photodetector comprises pixels extending on a plane of pixels. The photodetectors are arranged so that their respective planes of pixels are respectively at right angles to the first axis of orientation Δ₁, to the second axis of orientation Δ₂ and to the third axis of orientation Δ₃. Thus, each pixelated photodetector 30 is associated with a layer, and can acquire a spatially resolved signal, representative of the scintillation light emanating from the light guides formed in the layer. Optical systems 35, of objective or lens type, ensure an optical coupling between each photodetector and the light guides of the layer with which the pixelated photodetector is associated. In this example, three photodetectors are represented which are distinct from one another, and fixed relative to the multilayer scintillator 20. That allows for a simultaneous acquisition of the scintillation light generated in each layer. According to a variant, provision can be made for a pixelated photodetector 30 to be displaced between several successive positions, so as to collect, in each position, the scintillation light guided by the waveguides of a layer.

Preferably, at each position of the pixelated photodetector 30, the relationship between the pixels collecting the scintillation light is bijective, such that a light guide is optically coupled to a pixel, or a group of pixels, the pixels that are optically coupled to one light guide being different from the pixels that are optically coupled to another light guide. According to a variant, several light guides are optically coupled to one and the same pixel.

FIG. 4B illustrates a variant of FIG. 4A, according to which the light emanating from the light guides of certain layers is reflected by mirrors 36, to a photodetector 30 extending facing another layer. In this example, the pixelated photodetector 30 is situated facing the second layer 22. Mirrors 36 make it possible to reflect the scintillation light guided by the respective light guides of the first and third layers, to the pixelated photodetector 30. The use of such mirrors makes it possible to limit the number of photodetectors to be used, while allowing for a simultaneous acquisition of the scintillation light generated in several layers.

It is possible to provide a coupling of the light guides of a layer, to the pixels of a photodetector, by optical fibers. However, it is, preferable for this coupling to be effected by an optical system 35, which is less complex to implement. That also makes it possible to keep each photodetector 30 at a distance from the multilayer scintillator 20. Alternatively, the light guides can be directly coupled to the pixels of the photodetector. In such a case, it is preferable for an optical coupling fluid, of coupling oil or gel type, to be disposed at the interface between the pixels and the light guides, so as to obtain an index matching between the light guides and the pixels.

The pixelated photodetector 30 can be an image sensor, of CCD or CMOS type. The different layers of the multilayer scintillator 20 being offset from one another according to the irradiation axis Z_{Ω}, one and the same photodetector 30 can simultaneously address several layers, the pixels that are optically coupled to one layer being different from the pixels that are optically coupled to another layer. It is also possible to use linear sensors, comprising a strip of pixels extending along a row. Such sensors can be applied directly against the light guides emerging from a layer, even from each layer. An example of a linear sensor is the reference S11865-128 (Hamamatsu). The direct coupling of a sensor against the light guides of a layer enhances the compactness and can be produced from inexpensive and widely used linear sensors.

FIG. 5A represents a multilayer scintillator 20 whose transverse section, at right angles to the irradiation beam, describes a trapezoidal surface. A first layer 21, a 30 second layer 22 and a third layer 23 are represented. The first layer 21 comprises light guides 21_{g}, extending according to an axis of orientation Δ₁, according to an orientation θ₁ relative to the axis X. The light guides 21_{g} emerge from a first face F1, forming a plane transversal to the detection plane P, the latter corresponding to the plane XY. The first face F1 is, in this example, at right angles to the detection plane P, 35 which corresponds to a preferred configuration. The second layer 22 comprises light guides 22_{g}, extending, according to an axis of orientation Δ₂, according to an orientation θ₂ relative to the axis X. The light guides 22_{g} emerge from a second face F2, at right angles to the detection plane P. The third layer 23 comprises light guides 23_{g}, extending according to an axis of orientation Δ₃, forming an orientation θ₃ relative to the axis X. The light guides 23_{g} emerge from a third face F3, at right angles to the detection plane P. On each layer, the light guides extend from a thinner part of the plates 21ₛ, 22ₛ, 23ₛ, each thinner part corresponding to a residual part of the initial plate, under the channels.

At least one face, and preferably each face, can comprise an opaque mask covering the face, apart from the light guides emerging from said face. The opaque mask can be obtained by the application of an opaque coating on the face. It can for example be an opaque paint or an absorbent sheet, applied to the face. That prevents a scintillation light, not guided by a light guide, from emanating from a face of the multilayer scintillator, by emerging notably from a thinner part of a plate. The addition of the opaque mask on one or more faces can affect all the embodiments. The opaque mask can be reflecting.

FIG. 5B represents another configuration, according to which the multilayer scintillator 20 has a transverse section, at right angles to the irradiation beam, describing a pentagonal surface. In this example, the multilayer scintillator comprises five layers, extending respectively according to a first axis of orientation Δ₁, a second axis of orientation Δ₂, a third axis of orientation Δ₃, a fourth axis of orientation Δ₄ and a fifth axis of orientation Δ₅. The five layers respectively define five distinct orientations θ₁, θ₂, θ₃, θ₄ and θ₅. Other configurations can naturally be envisaged, the transverse section of the multilayer scintillator 20 being able to have a hexagonal, octagonal or, more generally, polygonal form.

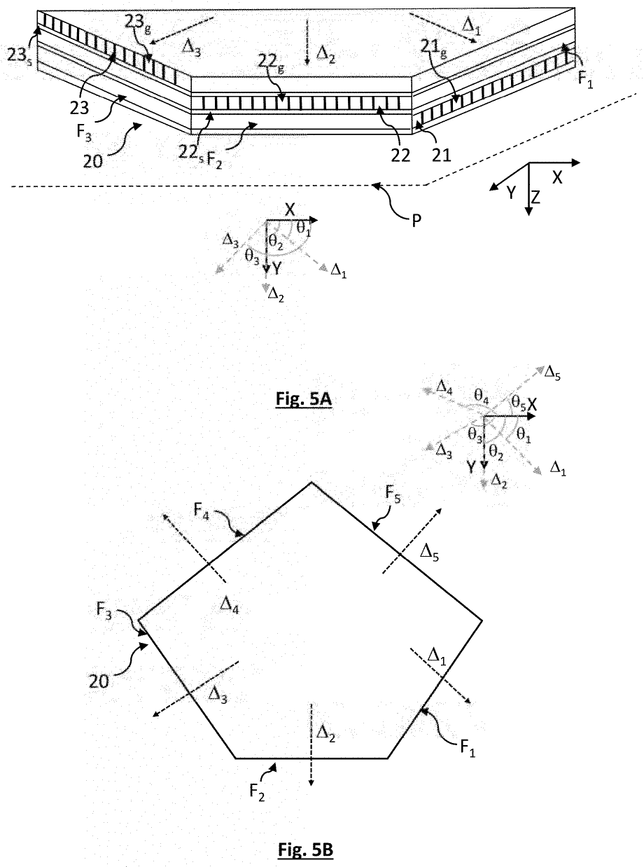

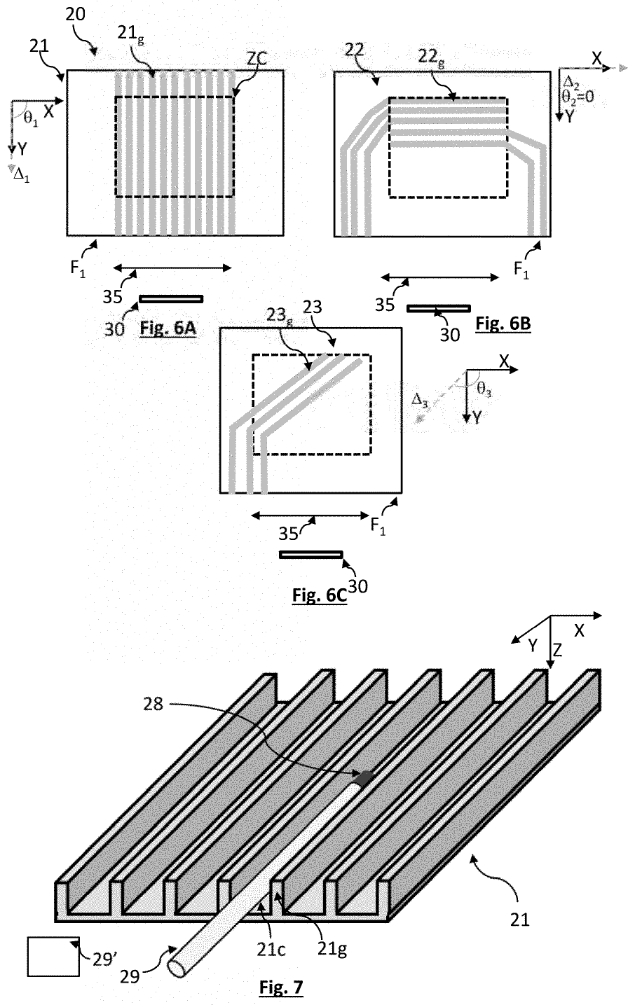

FIGS. 6A to 6C illustrate another configuration, according to which the multilayer scintillator 20 comprises three layers 21, 22, 23 superposed on one another. Each layer extends parallel to one another. In a central zone ZC of the scintillator, materialized by a dotted line box, each layer comprises light guides extending parallel to one another, according to an orientation associated with each layer. Thus:
in the first layer 21, the light guides 21_{g} extend according to an axis of orientation Δ₁, defining an orientation θ₁;
in the second layer 22, the light guides 22_{g} extend according to an axis of orientation Δ₂, defining an orientation θ₂;
in the third layer 23, the light guides 23_{g} extend according to an axis of orientation Δ₃, defining an orientation θ₃.

The central zone ZC of the scintillator 20 encompasses a projection of the aperture 13, defined by the collimator 12, according to the axis Z_{Ω} of the irradiation beam Ω, on the detection plane P according to which each layer extends. The projection of the irradiation beam in the detection plane P is designated by the term “irradiation field”.

Outside of the central zone ZC, the waveguides of one and the same layer are directed toward one and the same detection face F1, the latter being common to several layers, and in this particular case to all the layers. The fact that the light guides of several layers emerge from one and the same detection face makes it possible to collect the scintillation light generated in each light guide with one and the same pixelated photodetector 30, coupled to the optical system 35. In FIGS. 6B and 6C, only a part of the light guides is represented.

Regardless of the embodiment, when a light guide extends between an end coupled to a photodetector, and an end that is not coupled to a photodetector, the latter can be coated with a reflecting material, so as to return the scintillation light to the end of the light guide that is coupled to the photodetector. That makes it possible to increase the quantity of light collected by the photodetector which enhances the measurement sensitivity.

FIG. 7 illustrates a variant that can be applied to all the embodiments described in this application. According to this variant, a radiation detector, called auxiliary detector 28, is inserted into a layer 21, preferably by being introduced into a channel 21_{c} formed between two light guides 21_{g}. It is preferably a point detector, making it possible to obtain a quantitative value of a dose, or of a dose rate, generated by the irradiation beam Ω. The auxiliary detector 28 is preferably a solid state detector, so as to be sufficiently compact to be able to be inserted into the channel, bearing in mind that the width of a channel lies between a few tens of microns and a few hundreds of μm, being preferably less than 100 μm. In FIG. 7, the channels 21_{c} are represented as being wider, relative to the light guides 21_{g}, to make it possible to visualize the insertion of the auxiliary detector 28 into a channel 21_{c}. The detection volume of the auxiliary detector 28 is preferably less than 1 mm³, even 0.1 mm³. Given the compactness constraints, it is preferable for the auxiliary detector 28 to be a scintillator, for example based on GaN. The response of such a scintillator is insensitive to the angle of incidence of the irradiation beam, which makes it particularly suitable for taking measurements under strong irradiation, when the axis Z_{Ω} of the irradiation beam rotates about the scintillator. Furthermore, the small detection volume makes it particularly suitable for insertion into a narrow channel. The auxiliary detector is linked to an optical fiber 29, the latter extending between the auxiliary detector and an auxiliary reading circuit 29′ that is remote from the multilayer scintillator. The auxiliary reading circuit makes it possible to obtain a quantitative exposure value as a function of the light transmitted by the optical fiber 29.

Other scintillation materials can be implemented to form the auxiliary detector 28. Preference will be given to detectors that are compact, of weak remanence and compatible with strong irradiation levels, and insensitive to the incidence of the irradiation beam. Other scintillation materials capable of forming the auxiliary detector that can be cited include, non-exhaustively, BGO (bismuth germanate), CsI(TI) (thallium-doped cesium iodide), LSO (lutetium oxyorthosilicate), LYSO (scintillating crystal based on cerium-doped lutetium), GSO (gadolinium orthosilicate), or LaBr₃ (lanthanum bromide).

Several auxiliary detectors can thus be disposed in one and the same layer, even in different layers. Preferably, at least one auxiliary detector is disposed at the isocenter of the irradiation beam Ω. It is recalled that, in the case of stereotactic radiotherapy, the isocenter corresponds to the intersection of the successive irradiation axes Z_{Ω} during the rotation of the irradiation source.

The auxiliary detector 28 allows for an accurate estimation of a dose at a point. This information, accurate but isolated, can advantageously be combined with the estimation of the spatial distribution of the irradiation beam, in the detection plane, described hereinbelow. Spatial information is then combined with a spot quantitative measurement.

Whatever the embodiment, the multilayer scintillator can comprise marks forming reference points, visible by MRI. These marks can be symbols of dot, cross or line type, produced in a material forming an agent of contrast in MRI, for example gadolinium. It will thus be possible to delimit an outline of the multilayer scintillator or identify noteworthy points, for example a center of the scintillator in the detection plane P. It is specified that the multilayer scintillator is preferably amagnetic, which makes it compatible with use in the strong magnetic fields produced in examination by MRI.

Experimental trials were carried out by implementing a single-layer scintillator of square section, comprising a single layer, similar to the first layer 21 of the scintillator 20 described in association with FIGS. 2A and 2B. The layer 21 extends according to an axis of orientation Δ₁. It is thus associated with an orientation angle θ₁ of 90° relative to the axis X. The single-layer scintillator comprises 200 light guides 21_{g} of 1 mm height (according to the axis Z), spaced apart from one another according to a distance of 250 μm. A channel 21_{c} of 60 μm width (according to the axis X) extends between two adjacent light guides.

In order to check the capacity of the light guides to propagate the scintillation light, the multilayer scintillator was first of all exposed to a UV irradiation (375 nm) at right angles to the plane XY. The irradiation beam forms, in the detection plane, a rectangle of 8 mm (according to the axis X) by 50 mm (according to the axis Y). An optical system 35 and a photodetector 30 of CMOS sensor type (Andor Zyla 5.5 CMOS camera optically coupled to a Navitar 7000 macro zoom) was disposed opposite the face of the scintillator, extending according to a plane XZ. The face of the scintillator, an image of which is formed by the CMOS sensor, is designated “detection face”.

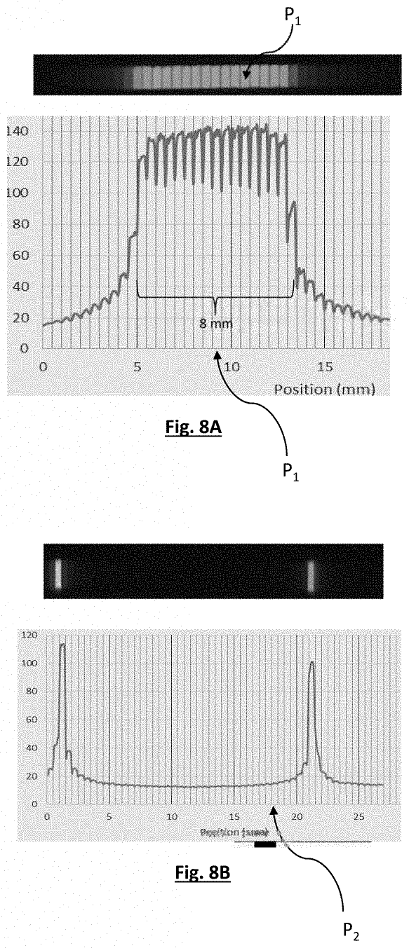

FIG. 8A represents an image of the detection face, acquired by the CMOS sensor. An intensity profile P₁ of this image was also added. The intensity profile makes it possible to trace back to a dimension of the irradiation beam at right angles to the axis of orientation Δ₁ of the first layer 21. Since the latter coincides with the axis Y, the profile makes it possible to trace back to a dimension of the irradiation beam according to the axis X, namely 8 mm. The profile obtained is thus representative of a projection of the irradiation beam according to the orientation θ₁.

During a second experimental trial, the UV irradiation was formed by two beams of 200 μm width (according to the axis X) and of respective lengths (according to the axis Y) equal to 47.5 mm and 40 mm. FIG. 8B represents an image of the detection face F1, acquired by the matrix photodetector. An intensity profile P₂ of this image was also added. The profile makes it possible to appreciate the spatial resolution of the scintillator. This figure attests to the good spatial resolution permitted by the structuring of the layer in light guides. The intensity of the signal emanating from a light guide corresponds to the exposure to which the light guide is subjected, over all the length of the guide exposed to the irradiation. The difference in amplitude of the two peaks is attributed to the different length of the beams according to the axis Y.

During another series of tests, the single-layer scintillator was exposed to an irradiation beam Ω of X photons from an accelerator raised to the 6 MV potential, the dose rate rising to 14 Gy/minute. The length of the beam, according to the axis Y, rose to 10 cm. The width of the beam, according to the axis X, was successively set at 3 cm, 2 cm, 1 cm, 0.5 cm and 0.1 cm. FIGS. 9A, 9B, 9C, 9D and 9E represent the images obtained by the waveguides emanating from the detection face of the single-layer scintillator, respectively for the 3 cm, 2 cm, 1 cm, 0.5 cm and 0.1 cm widths. Each image was acquired according to a duration of 10 ms, corresponding to a few pulses of the particle accelerator. These images attest to the capacity of a layer of the scintillator to make it possible to estimate a dimension of the irradiation field according to a direction at right angles to the orientation associated with the layer. They respectively represent a projection of the irradiation beam Ω according to the orientation associated with each layer. These images also show that the structuring of the layer in waveguides makes it possible to measure an irradiation beam dimension of small width, for example 0.1 cm.

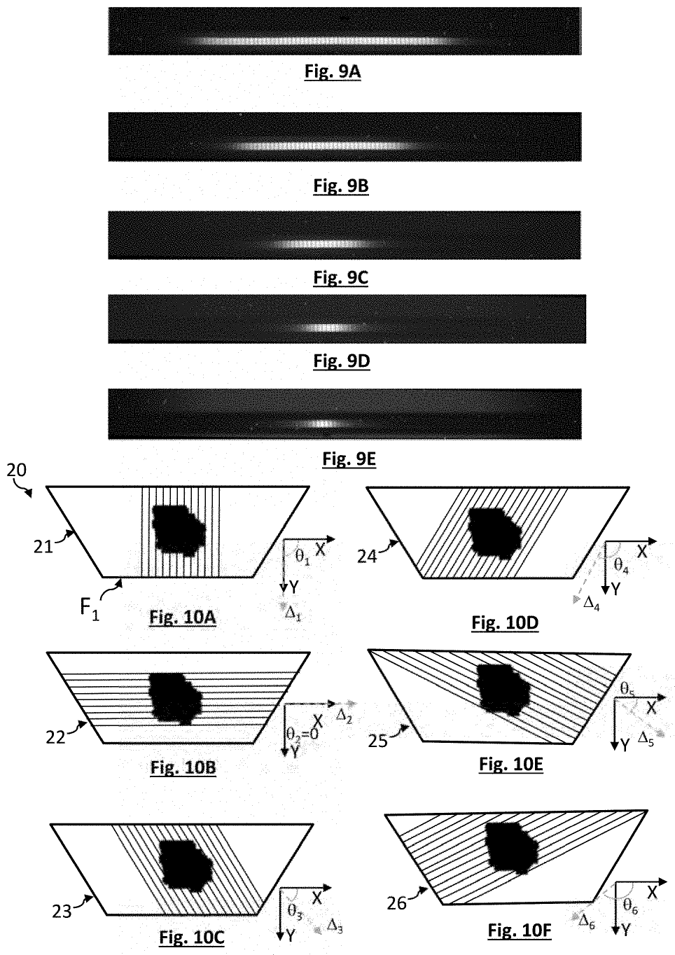

During another series of tests, the use of a scintillator of trapezoidal section, similar to the example described in association with FIG. 5A, was simulated. According to this configuration, the scintillator comprises six layers 21, 22, 23, 24, 25, 26, each layer extending respectively according to an axis of orientation Δ₁Δ₂, Δ₃, Δ₄, Δ₅, Δ₆. Each layer is thus respectively associated with an angle of orientation θ₁, θ₂, θ₃, θ₄,θ₅, θ₆, each angle of orientation being different from one another. Each layer is respectively schematically represented in FIGS. 10A to 10F. Each light guide has a height of 500 μm (according to the axis Z), and a width equal to 250 μm, at right angles to the axis of orientation according to which the light guide extends. Two adjacent light guides are spaced apart by a channel of 60 μm thickness. Each layer comprises 215 light guides. The thickness of the multilayer scintillator 20, at right angles to the detection plane XY, is 3 mm. The great length can be of the order of 100 mm and a small length of may be of the order of 75 mm.

FIGS. 10A to 10F also show a form of an irradiation beam Ω, in the central part of each, layer. In FIGS. 8A and 8B, and in FIGS. 9A to 9E, it was observed that the light emanating from the light guides of a layer makes it possible to obtain a projection of the irradiation beam according to the orientation of the layer. By multiplying the number of layers, this property can be exploited to produce a tomography of the irradiation beam Ω in the detection plane, considering that each layer extends according to one and the same detection plane. For that, the thickness ε of the multilayer scintillator is disregarded. It is preferable for the number of layers to be between 3 and 20. That makes it possible to obtain a sufficient number of projections, while retaining a reasonable thickness of the multilayer scintillator.

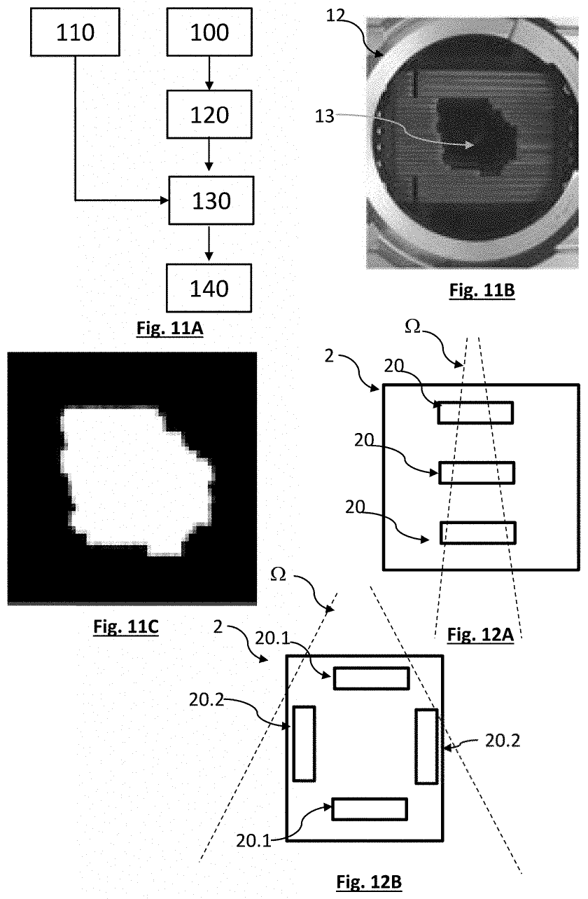

FIG. 11A represents the main steps of a tomography method implementing the multilayer scintillator.

Step 100: arrangement of the multilayer scintillator 20 in an irradiation beam Ω, the scintillator extending in a detection plane P. In this example, the detection plane P is orthogonal to the axis of irradiation P_{Ω}, but this condition is not essential.

Step 110: parameterizing of the tomography. This involves performing a modelling so as to obtain a transfer matrix M. The detection plane is discretized into a number of individual meshes and a transfer matrix is calculated, in which each term M(i,j) corresponds to a contribution to the light intensity measured at the output of a light guide i of the scintillator when a mesh j is exposed to a given irradiation level. Establishing such a transfer matrix is a conventional step in tomography. The dimension of the matrix is I×J, in which denotes the number of waveguides and J denotes the number of meshes.

Step 120: acquisition, by one or more pixelated photodetectors, of images representative of the quantity of light emanating from the light guides respectively formed in each detection layer. A projection of the irradiation beam is then obtained according to the orientation respectively associated with each layer. When there is a sufficient number of pixels, for example by using an imager, the acquisition of the images can be simultaneous, so as to obtain information as to the extent and the intensity of the irradiation beam. The quantity of each signal can form a measurement vector V, of which each term V(i) is representative of a signal quantity collected by each vector. The dimension I of the measurement vector corresponds to the numbers of waveguides taken into account.

Step 130: inversion. This involves determining an irradiation vector W, each term W(j) of which corresponds to an irradiation quantity detected in a mesh j. The dimension of the irradiation vector corresponds to the numbers J of meshes taken into account. The measurement vector V, the transfer matrix M and the irradiation vector are linked by the equation: V=M×W. The inversion allows for an estimation of the vector W that best satisfies this relationship. It is performed according to different methods known to a person skilled in the art.

Step 140: obtaining of a two-dimensional spatial distribution of the irradiation beam Ω, from the irradiation vector W estimated in the preceding step.

Another example of a tomography algorithm is also described in the publication by Goulet M., “High resolution 2D measurement device based on a few long scintillating fibers and tomographic reconstruction”, cited in the prior art.

FIG. 11B represents an aperture 13 formed in a plate collimator 12 as previously described. The algorithm summarized in association with FIG. 11A was implemented, based on simulations performed by using the six-layer scintillator represented in FIGS. 10A to 10F. A two-dimensional spatial distribution of the irradiation beam was obtained as represented in FIG. 11C. The result obtained (FIG. 11C) is consistent with the aperture produced in the collimator (FIG. 11B).

When the multilayer scintillator comprises an auxiliary detector, the latter can be used to perform a realignment of the two-dimensional spatial distribution obtained from an exposure value measured by the auxiliary detector. Spatial information is then combined with one or more spot quantitative measurements.

The multilayer scintillator 20 described above will be able to be used to predict the dosimetry prior to radiotherapy interventions, in particular in stereotactic radiotherapy. It will for example be possible to arrange several multilayer scintillators 20, parallel to one another, in a phantom 2, as represented in FIG. 12A. That makes it possible to obtain the extent of an irradiation beam according to different planes, at different distances from the irradiation source 11. That makes it possible to obtain a trend, according to the axis of the irradiation beam, of the two-dimensional spatial distribution of the irradiation beam Ω.

It is also possible to envisage arranging different multilayer scintillators respectively in different planes, so, as to obtain a two-dimensional spatial distribution of the irradiation beam respectively in the different planes. FIG. 12B represents several multilayer scintillators extending in a phantom according to different orientations. Two scintillators 20.1 are disposed such that the detection plane is orthogonal to the axis of the irradiation beam Ω, while two other scintillators 20.2 are disposed such that their detection plane is parallel to the axis of the irradiation beam Ω.

Whatever the disposition of the multilayer scintillator or scintillators, the phantom 2 can comprise a point detector, for example a GaN scintillator of small volume, typically less than 1 mm³, at the isocenter.

1-22. (canceled)

23. A multilayer scintillation detector, comprising at least three layers superposed on top of one another, and each extending parallel to a detection plane, wherein:
each layer comprises a first scintillation material, that is configured to interact with an ionizing radiation and form, following the interaction, a scintillation light;
each layer comprises a plurality of light guides, respectively extending parallel to the detection plane, according to a length, the light guides comprising the first scintillation material and being disposed, over all or part of their length, parallel to an orientation axis;
the orientation axis of the light guides of one layer is oriented, in the detection plane, according to an orientation, such that each layer has an associated orientation, the orientations of the respective orientation axes of at least three layers being different from one another;
the first scintillation material has a first refractive index;
each layer is formed by a plate, comprising the first scintillation material, extending parallel to the detection plane;
the plate comprises channels, formed in the plate, and extending parallel to the detection plane, along the orientation associated with the layer;
each channel is filled by a second material, of a second refractive index, lower than the first refractive index; and
a light guide extends, between two adjacent channels, the light guide being formed by the first scintillation material, the light guide being configured to generate a scintillation light when irradiated by the ionizing radiation, and to propagate the scintillation light along the orientation axis of the layer.

24. The detector of claim 23, wherein each light guide of one layer extends, along the detection plane, to a detection face of the detector, the detection face being disposed transversely to the detection plane, so that the scintillation light generated in the light guide is propagated toward the detection face.

25. The detector of claim 24, wherein the detection face is perpendicular to the detection plane.

26. The detector of claim 23, comprising several detection faces, each detection face comprising ends of light guides formed in one and the same layer.

27. The detector of claim 23, wherein at least one detection face comprises ends of light guides formed in different layers.

28. The detector of claim 23, wherein the detection plane comprises a polygonal section.

29. The detector of claim 23, wherein a height of at least one light guide, perpendicularly to the detection plane, lies between 100 μm and 1 mm.

30. The detector of claim 23, wherein a width of a light guide in the detection plane, perpendicularly to the orientation axis along which the light guide extends, lies between 100 μm and 500 μm.

31. The detector of claim 23, wherein the second material is air.

32. The detector of claim 23, wherein the first scintillation material is an organic scintillator.

33. The detector of claim 23, wherein at least one layer is separated from another layer, which is superposed on it, by a thickness of a third material, wherein the third material is
of a third optical index, lower than the first optical index;
and/or opaque;
and/or reflecting.

34. The detector of claim 23, wherein at least one layer comprises an auxiliary detector, disposed in a measurement channel formed within the layer, the auxiliary detector being configured to induce an optical or electronic signal when irradiated by the ionizing radiation.

35. The detector of claim 34, wherein the auxiliary detector is formed by a solid state material, the solid state material being connected to an optical or electrical connection, the connection extending in the measurement channel.

36. The detector of claim 35, wherein the auxiliary detector is a point detector, the auxiliary detector having a detection volume less than 1 mm³.

37. The detector of claim 35, wherein the auxiliary detector is a scintillation detector connected to an optical fiber, the latter forming the optical connection.

38. The detector of claim 23, wherein the detector comprises marks, formed on at least one layer, using a material forming a contrast agent in an examination by magnetic resonance imaging, such that the marks form reference points that are visible when the detector is examined by magnetic resonance imaging.

39. A device for detecting an ionizing radiation, comprising:
the multilayer scintillation detector of claim 23, the multilayer scintillation detector being formed in a scintillation material configured to generate a scintillation light when irradiated by the ionizing radiation:
at least one pixelated photodetector, comprising several pixels;
wherein each pixel is configured to be optically coupled to a light guide formed in a layer of the multilayer scintillation detector, so as to collect the scintillation light emanating from the light guide to which it is coupled.

40. The device of claim 39, comprising at least one optical coupling system, such that each pixel is optically coupled to a light guide by the optical coupling system.

41. The device of claim 39, wherein at least one layer of the multilayer scintillation detector comprises an auxiliary detector, disposed in a measurement channel formed within the layer, the auxiliary detector being configured to induce an optical or electronic signal when irradiated by the ionizing radiation, the detection device further comprising a measurement unit, connected to the auxiliary detector, and configured to measure a level of irradiation detected by the auxiliary detector.

42. The device of claim 41, wherein the auxiliary detector is a scintillator type, connected to an optical fiber, the optical fiber extending in the measurement channel.

43. A method for reconstructing a two-dimensional spatial distribution of an irradiation beam emitted by an irradiation source, using the detection device of claim 39, the method comprising:
a) irradiating the multilayer scintillation detector, of the detection device, by the irradiation source, the multilayer scintillation detector extending parallel to a detection plane, the irradiation source producing an irradiation beam that is propagated through the detection plane;
b) detecting, by pixels of the detection device, a quantity of scintillation light emanating from each layer of the multilayer scintillation detector, so as to obtain, for each layer, a projection of the irradiation beam, in the detection plane, according to the orientation of the light guides of each layer; and
c) from each projection obtained in b). estimating a two-dimensional spatial distribution of the irradiation beam in the detection plane.

44. The method of claim 43, wherein:
the multilayer scintillation detector further comprises an auxiliary detector, in a measurement channel formed within a layer of the multilayer scintillation detector, the auxiliary detector being configured to induce an optical or electronic signal when irradiated by the irradiation beam; and
the detection dev ice comprising a measurement unit, connected to the auxiliary detector, and configured to measure a level of irradiation detected by the auxiliary detector;
the method further comprising a step d) of adjusting the two-dimensional spatial distribution estimated in the step e) based on the level of irradiation detected by the auxiliary detector.

45. The method of claim 43, wherein steps a) to c) are performed by arranging the multilayer scintillation detector at different distances from the irradiation source, so as to obtain, for each distance, a two-dimensional spatial distribution of the irradiation beam.
